(19) United States
(12) Patent Application Publication
(10) Pub. No.: US 2008/0211731 A1
(43) Pub. Date: Sep. 4, 2008

(54) VIDEO DATA TRANSMITTING APPARATUS, COMMUNICATION SYSTEM, DISPLAY DEVICE, AND VIDEO TRANSMITTING METHOD

(75) Inventors: Shinya Murai, Kawasaki-shi (JP); Hajime Yamaguchi, Kawasaki-shi (JP); Tsuyoshi Hioki, Yokohama-shi (JP); Shogo Yamaguchi, Kawasaki-shi (JP); Mitsue Fujinuki, Tokyo (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/020,208

(22) Filed: Jan. 25, 2008

(30) Foreign Application Priority Data
Feb. 7, 2007 (JP) 2007-028370

(51) Int. Cl. G09G 5/00

(52) U.S. Cl. 345/1.1

(57) ABSTRACT

A video data transmitting apparatus includes a memory to store management information indicating corresponding relation between identification information elements for identifying a plurality of stackable display devices and orders of the display devices, an image data generator to generate a plurality of image data streams having a sequence according to the sequence, and a image data transmitter to transmit the image data streams to the display devices with order relation among the image data streams matching with order relation among the display devices based on the management information.

### CROSS-REFERENCE TO RELATED APPLICATIONS

This application is based upon and claims the benefit of priority from prior Japanese Patent Application No. 2007-028370, filed Feb. 7, 2007, the entire contents of which are incorporated herein by reference.

### BACKGROUND OF THE INVENTION

1. Field of the Invention

The present invention relates to a video data transmitting apparatus, a video data communication system, a display device, and a video transmitting method.

2. Description of the Related Art

In recent years, very thinned/light weighted display devices have been developed. Accordingly, it is conceivable to make a display stack by stacking a plurality of thin sheet-shaped display devices like a brochure and use the display stack with it in the user's hand or by putting it on a desk. On that occasion, it is desired to provide a technology capable of dealing with change of adjacent relation between the display devices even if the number of information items (e.g., the number of pages), the number of display devices or adjacent relation between the display devices (e.g., upper/lower relation of stacked display devices) is changed, when a plurality of information items are displayed in a decided order.

On the other hand, improvement of wireless communication technology makes it possible to attach a wireless communication interface to each of the thin and lightweight display devices and to transmit information items to the display devices respectively via a network to display an image on each of the display devices.

J. Jacobson, B. Comiskey, C. Turner, J. Albert, P. Tsao, “The last book”, International Business Machines Corporation, IBM Systems Journal VOL. 36 No. 3, 1997, p 457-463, discloses a technology to make a brochure using thin lightweight display devices. According to this technology, a plurality of thin and lightweight display devices are fixed in the number and the order beforehand.

JP-A 2003-61140 (KOKAI) and JP-A 2005-173291 (KOKAI) disclose a technology of providing information to the display devices via wireless communication interfaces and displaying the information on them. However, JP-A 2003-61140 (KOKAI) and JP-A 2005-173291 (KOKAI) disclose simply a technology that when the display device is put at an arbitrary position on a map merely, the image information according to the position is provided to the display device through the wireless communication IF, and displayed thereon.

In prior art, when a plurality of image data having order relation are transmitted to each display device from an image data transmitter, and displayed, in the case of making the order relation of a plurality of display devices coincide with the order relation of a plurality of image data, even if the number of image data (e.g., the number of pages), the number of display devices, the total number of display screens or the order relation of the display devices is changed, it is impossible to realize a system capable of dealing with the change flexibly.

It is an object of the present invention to provide a video data transmitting apparatus capable of dealing with change of the number of image data (e.g., the number of pages), the number of display devices, the total number of display screens or the order relation of the display devices, and a video data communication system including the same, a display device for the same, and a video transmission method for the same.

### BRIEF SUMMARY OF THE INVENTION

An aspect of the present invention provides a video data transmitting apparatus to transmit video data to a plurality of stackable display devices individually, the apparatus comprising: a memory to store management information indicating corresponding relation between identification information elements for identifying a plurality of stackable display devices and orders of the display devices; an image data generator to generate a plurality of image data streams having a sequence according to the sequence; and a video data transmitter to transmit the image data streams to the display devices with order relation among the image data streams matching with order relation among the display devices based on the management information.

### BRIEF DESCRIPTION OF THE SEVERAL VIEWS OF THE DRAWINGS

FIG. 1 is a diagram illustrating a video transmitting apparatus according to a video communication system according to an embodiment.

FIG. 2 is a diagram illustrating an example of order relation information.

FIG. 3 is a flow chart illustrating a processing flow of the video transmitting apparatus.

FIG. 4 is a flow chart illustrating another processing flow of the video transmitting apparatus.

FIG. 5 is a block diagram of a display device.

FIG. 6 is a plan view of a display device with an infrared signal transmitter.

FIG. 7 is a plan view of a display device with an infrared signal receiver.

FIG. 8 is a diagram illustrating a stacked state of adjacent display devices with an infrared signal receiver and an infrared signal transmitter which are faced to each other.

FIG. 9 is a block diagram of another video data transmitting apparatus according to the embodiment.

FIG. 10 is a diagram illustrating an example of information stored in a video data memory.

FIG. 11 is a flow chart illustrating a procedure for notifying a video data transmitting apparatus of unit order information from a display device.

FIG. 12 is a flow chart illustrating another procedure for notifying a video data transmitting apparatus of unit order information from a display device.

FIG. 13 is a flow chart illustrating a procedure for creating and updating order relation information by means of a video data transmitting apparatus based on unit order information received from a display device 2.

FIG. 14 is a flow chart illustrating a processing flow of a video data transmitter.

FIG. 15 is a flow chart illustrating a processing flow of a video data transmitter.

FIG. 16 is a flow chart illustrating a processing flow of a video data transmitter.

FIG. 17 is a diagram illustrating an example of order relation information.

FIG. 18 is a diagram illustrating groups of stacked display devices.

FIG. 19 is a diagram illustrating an example of order relation information.

FIG. 20 is a diagram illustrating an example of order relation information.

FIG. 21 is a diagram illustrating an example of order relation information.

### DETAILED DESCRIPTION OF THE INVENTION

There will now be described an embodiment of the present invention in conjunction with the accompanying drawings.

### First Embodiment

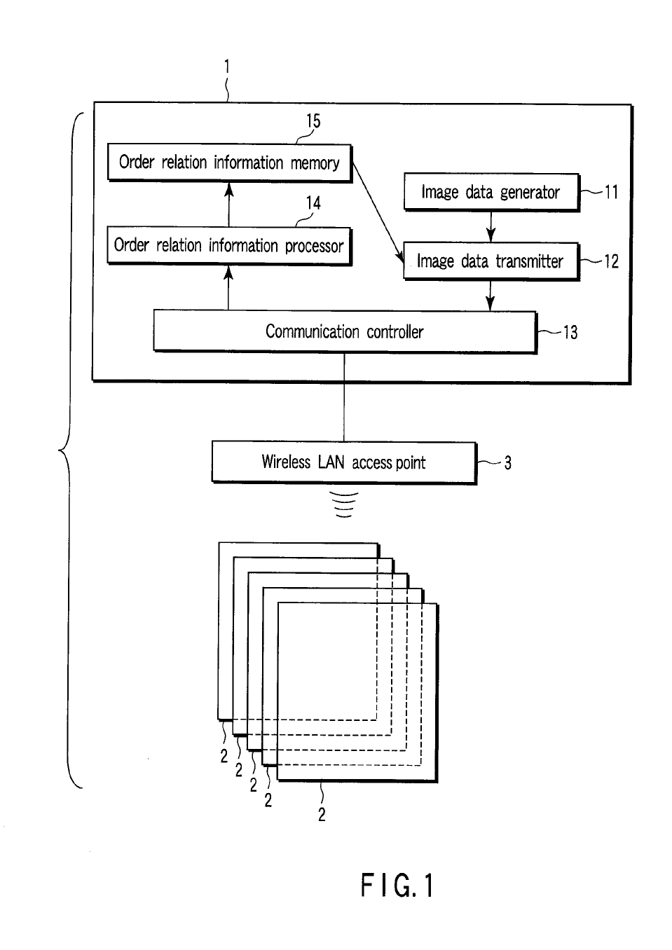

As shown in FIG. 1, the present video data communication system includes a video data transmitting apparatus 1 to transmit video data to be displayed (referred to as a display image) and a plurality of display devices 2 to display the video data received from the video data transmitting apparatus (video data transmitter) 1.

The video data transmitting apparatus 1 transmits the display images to be displayed on the display devices 2 to the display devices 2 at given timings corresponding to the display devices 2. As described below in detail, in the present embodiment, the display images are ordered in display order. The display devices 2 also are ordered in display order (automatically at a suitable timing). Accordingly, the video data transmitting apparatus 1 transmits each display image to the display device 2 to which the order corresponding to the display order is assigned currently. When receiving a display image from the video data transmitting apparatus 1, the display device 2 displays the display image on its display unit 21.

If the display device 2 can display the display image, the display image may have any data format such as video data compressed by JPEG and the like.

In the present embodiment, the display device 2 is assumed to be a thin-shaped (thin-shaped/light-weighted) display device having a shape such as a plastic sheet (referred to as a display sheet hereinafter). The case that a user can handle individual display sheets 2 like paper, or a stack of plural display sheets like a brochure (for example, flip a page, dispose them, or take along them) is assumable. The display sheet 2 falls under, for example, an electronic paper display or a flexible display.

All display sheets 2 need not always be identical with regard to the performance of each display sheet 2, the appearance shape thereof, the display screen shape thereof, etc. In the embodiment, the display sheet 2 is assumed to be a one side display type in which a display unit is provided only on a single side of the display sheet 2. There is described a both-side display type in which display units are provided on the both sides of the display sheet respectively.

In the present embodiment, the communication interfaces provided on the video data transmitting apparatus 1 and the display sheet 2 respectively are not limited in type. However, it is desirable to use a radio communication interface for at least the display sheet 2, because it becomes easy to use the display sheet 2 with it in the user's hand like a paper document. The radio interface may use any matter such as a wireless LAN, Bluetooth, an infrared ray device. There is described a display sheet using a radio communication interface hereinafter.

As shown in FIG. 1, a wireless LAN access point 3 is connected to the video data transmitting apparatus 1 for radio communication between the video data transmitter and each display sheet 2. In this case, the video data transmitting apparatus 1 and the wireless LAN access point 3 may connected directly to each other or via LAN and/or WAN. There is not a limit for positional relation among the video data transmitting apparatus 1, the wireless LAN access point 3 and the display sheets 2. The wireless LAN access point 3 and the display sheets 2 may be located in proximity to the video data transmitting apparatus 1 or away from the video data transmitting apparatus 1.

Using a communications unit built-in the video data transmitting apparatus 1 or a communications unit connected to the video data transmitting apparatus 1 instead of the wireless LAN access point 3, a display image may be transmitted from the video data transmitting apparatus 1 to the display sheets 2 directly. In this case, a positional relation between the video data transmitting apparatus 1 and the wireless LAN access point 3 or the communications apparatus 2 is not limited.

As shown in FIG. 1, the video data transmitting apparatus 1 comprises an image data generator 11, an image data transmitter 12, a communication controller 13, an order relation information processor 14, and an order relation information memory 15.

The communication controller 13 is a communication interface for transmitting data to a network or receiving data from the network. The present embodiment uses IP (Internet Protocol) as a protocol used for transmitting and receiving data. However, the protocol is not limited to IP, and may use another protocol.

The image data generator 11 generates display images having respective orders. The image data generator 11 generates a display image corresponding to each of plural information elements having respective orders. More concretely, the image data generator 11 generates a display image (image data stream) for each page about document data of a plurality of pages, for example.

When receiving a drawing command for drawing contents to be displayed on each page from application software capable of displaying the document data, the image data generator 11 may generate a display image based on the drawing command.

The timing at which the display image is generated is, for example, a timing indicated by a user. It is a timing at which a user indicates to display document data of a plurality of pages displayed by the application software on the display sheets 2.

In the above description, the image data generator 11 is assumed to generate a display image. However, a plurality of display images having the order that are already generated may be input from an input measure (not shown) via a communication medium or a storage medium. In this case, the image data generator 11 may be omitted. In the case that a display image generated by the image data generator 11 or a display image input by the input measure (not shown) is stored in a storage once and then is supplied to the communication controller 13, an image data memory such as FIFO to store the display image temporarily is provided.

The order relation information memory 15 stores information (order relation information) indicating an order relation among a plurality of display sheets 2.

There will be explained an order relation among the display sheets. The state that the display sheets 2 are stacked (bundled up) so that the display screens of all the display sheets 2 face in the same direction is assumed to be a basic brochure state. In this basic brochure state, only the display sheet 2 capable of browsing a display face is assumed to be the top screen, and the display sheet 2 showing a face opposite to the display face is assumed to be the backmost face. In this state, the display sheets 2 are ordered in order from the top display sheet 2 to the backmost display sheet. For example, when there are n display sheets, the top display sheet is “the first”, the display sheet to be stacked behind the top display sheet is “the second”, . . . , the display sheet adjacent to the backmost display sheet to be stacked before the backmost display sheet is “the (n−1)-th”, and the backmost display sheet is “the n-th”.

An operation for replacing the top display sheet from a certain basis brochure state to the backmost to form a new basis brochure state is referred to as a forward rotation. An operation for replacing the backmost display sheet from a certain basis brochure state to the top to form a new basis brochure state is referred to as a backward rotation.

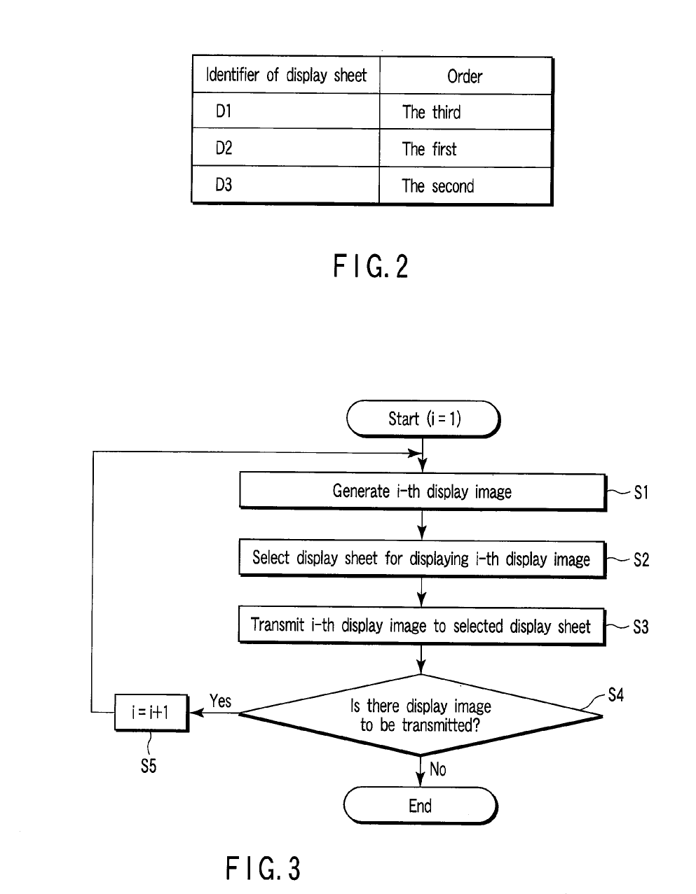

An example of the order relation information stored in the order relation information memory 15 is shown in FIG. 2. In this example, the order relation information includes information indicating correspondence between the identifier of the display sheet and the order of the display sheet with respect to a plurality of display sheets. In the example of FIG. 2, when a user uniforms three display sheets 2 in the basic brochure state, the display sheet D2 is top, the display sheet D3 is next, and the display sheet D1 is backmost.

An IP address may be used for the identifier of the display sheet 2, when IP is used for a communication protocol, for example. A host name may be used for the identifier in the case of the environment capable of using DNS, for example. It may be an unique number for searching a prepared database for an IP address or a host name. In other words, if the identifier can identify uniquely the display sheet 2 and acquire information to be necessary to communicate with the display sheet 2 individually, it may be any identifier.

When the system is fixed, that is, the number of display sheets 2 and the order relation among them are fixed, the order relation information has only to be set at the time when the system is built up. However, when the system is not fixed, that is, the number of display sheets 2 is fixed, but the order relation among the display sheets 2 is not fixed, alternatively, when the number of display sheets 2 and the order relation among the display sheet 2 are not fixed, the order relation information must be created and updated at a suitable timing. In order for this to be realized it is desired to receive information concerning the identifiers of the display sheets 2 and the order relation among them via a network.

The order relation information processor 14 is used for realizing the above and creates or updates the order relation information based on the information notified by each display sheet 2. This method is explained in detail later.

The image data transmitter 12 transmits the display image corresponding to each display sheet 2 so that the order of display images received from the image data generator 11 coincides with the order of a plurality of display sheets 2 referring to the order relation information stored in the order relation information memory 15. Concretely, the first document image is sent to the top display sheet 2, the second document image to the display sheet 2 following the top display sheet, . . . . Also, the image data transmitter 12 obtains information necessary for communication from each of the identifiers of display sheets 2 which are stored in the order relation information memory 15, and transmits an display image to each display sheet 2.

As a result, the display image can be displayed on the stacked display sheets 2 connected to the video data transmitting apparatus 1 via the network with a state that the order relation among the documents coincides with the order relation among the display sheets 2. Therefore, the stacked display sheets 2 can be used as a document made by stacking a plurality of papers usually used.

When the image data transmitter 12 transmits a display image to the display sheet 2, it is preferable to transmit the first display image to the top display sheet 2 and display it thereon. This is because it is very likely that the display sheet 2 which a user looks at is the top display sheet 2.

An example of the processing procedure of the video data transmitting apparatus 1 is shown in FIG. 3. In this example, the number m of display sheets 2 is assumed to be not less than the number n of display images. When the system is not fixed, the creation or updating of order relation information is assumed to be performed before the following procedure.

At first, the process is started for i=1, and the image data generator 11 generates the first display image (step S1). The image data transmitter 12 selects the first display sheet 2 for displaying the first display image, referring to the order relation information memory 15 (step S2), and transmits the first display image to the selected display sheet 2 (step S3). Thereafter, a procedure of generating the i-th display image as incrementing i one by one and transmitting the i-th display image to the i-th display sheet is repeated while there is a display image to be transmitted (steps S4, S5).

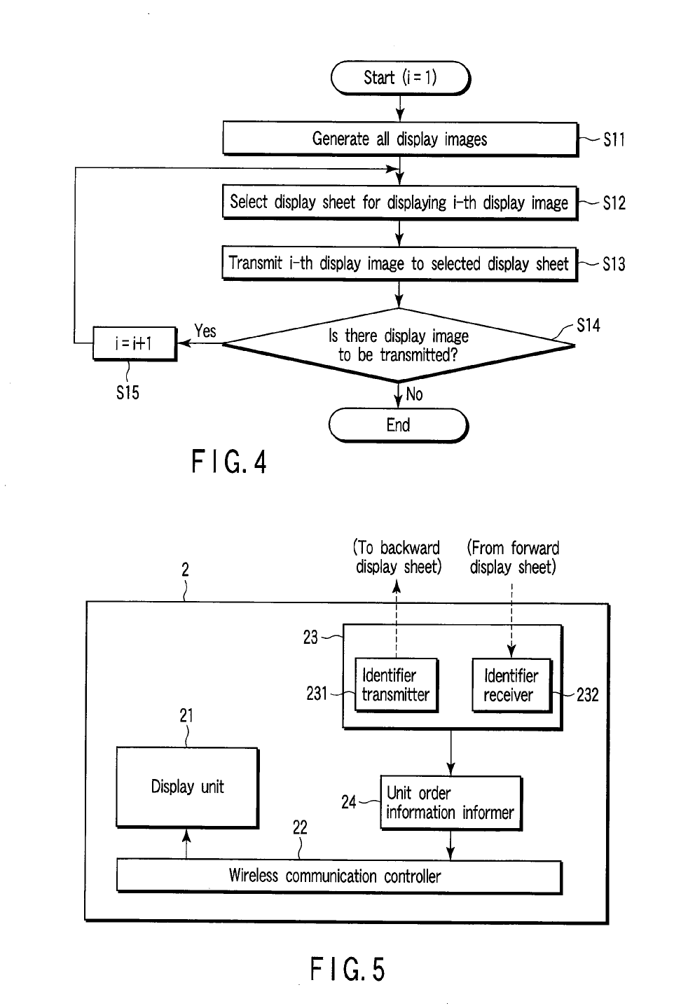

Another example of the video data transmitting apparatus 1 is shown in FIG. 4. In this example, the number m of display sheets 2 is assumed to be not less than the number n of display images. When the system is not fixed, the creation or updating of order relation information is assumed to be performed before the following procedure.

At first, the process is started for i=1, and the image data generator 11 generates all display images collectively (step S1). Subsequently, the image data transmitter 12 selects the first display sheet 2 for displaying the first display image, referring to the order relation information memory 15 (step S12), and transmits the first display image to the selected display sheet 2 (step S13). Thereafter, a procedure of generating the i-th display image as incrementing i one by one (step 15) and transmitting the i-th display image to the i-th display sheet is repeated while there is a display image to be transmitted (step S14).

The processing procedure of the video data transmitting apparatus 1 may be modified to various variations other than the procedure described above.

There will be described the configuration of the display sheet 2 referring to FIG. 5. As shown in FIG. 5, the display sheet 2 comprises a display unit 21, a communication controller 22, an adjacent display sheet detector 23, and a unit order information notification unit 24.

The communication controller 22 is a radio communication interface for transmitting data to a wireless LAN and receiving the data from the wireless LAN. The display unit 21 displays the display image received from the video data transmitting apparatus 1. The adjacent display sheet detector 23 and the unit order information notification unit 24 are provided in the case that the system is not fixed, for example, the case that the number of display sheets is fixed but the order relation among the plural display sheets is not fixed, or the case that the number of display sheets 2 and the order relation among the display sheets are not fixed.

In the case of the system of the present embodiment, when the order relation among the display sheets 2 is not fixed, the display sheets 2 may be stacked in what order at the time of transmission of the display image. Therefore, it is preferable that the order relation among the plural display sheets 2 is not fixed. The order in which the display sheets 2 are stacked at the time of transmission of the display image is detected as a real order relation. When a document image is transmitted to the stack of display sheets 2, the user can extract only one display sheet corresponding to a specific page of the document image from the stack of display sheets 2 and browser the page of the document. When the extracted display sheet 2 is changed back into the stacked state, the display sheets 2 may be changed back into the original order relation. However, the display sheets 2 may be stacked in approximate order and the new order relation may be registered with the order relation information memory 15. In this case, by executing the procedure of transmitting the display image again, the display sheets can be changed back into the same state as that of the original order relation. It will be appreciated that various functions other than the above function can be realized.

In this way, it is preferable that the order relation among the display sheets 2 is not fixed. However, in this case, a structure for registering variable order relation among the display sheets 2 with the order relation information memory is necessary. In this case, each display sheet 2 has only to detect an identifier of a display sheet 2 which is adjacent to a specific direction (a forward direction (a direction of its display face) or a backward direction (a direction of its non-display face)), and notify the video data transmitter of unit order information including this identifier and the identifier of itself. When the specific direction is a forward direction, the adjacent display sheet 2 is not detected in the top display device, and when it is a backward direction, the adjacent display sheet 2 is not detected in the backmost display sheet. Each display sheet 2 notifies the video data transmitting apparatus 1 of absence of the adjacent display sheet 2 (or that it is the top one or backmost one) instead of the identifier of the adjacent display sheet 2.

The order relation information processor 14 of the video data transmitting apparatus 1 can build order relation information concerning order relation among all display sheets 2 based on unit order information including the identifier of each display sheet 2 and the identifier of the display sheet 2 adjacent to the display sheet 2 (in a specific direction) or absence of the adjacent display sheet 2 (or that the object display sheet is the top display sheet or the backmost display sheet).

This notification has only to be done using a network connecting between the video data transmitting apparatus 1 and each display sheet 2. When there is another communication channel aside from the network, the communication channel may be used. In this way, when the system is not fixed, the IP address of the connectable display sheet 2 and information of the display sheets 2 before and after each display sheet 2 has only to be acquired using a service discovery protocol such as UPnP.

There will be explained a method that each display sheet detects an identifier of the display sheet 2 adjacent to itself in a specific direction (a predetermined one of the forward and backward directions) when viewed from itself, hereinafter.

The adjacent display sheet detector 23 is configured so that each display sheet 2 is able to acquire an identifier of the display sheet adjacent to itself in a specific direction when viewed from itself. The unit order information notification unit 24 is configured to notify the video data transmitting apparatus 1 of unit order information including information concerning an order relation between itself and the display sheet 2 adjacent to itself in the specific direction.

An identifier receiver 232, for example, an infrared signal receiver is mounted on the surface of each display sheet in the specific direction. In other words, when the surface of the display sheet in the specific direction is top, the identifier receiver 232 is mounted on the display surface. When the surface is back, identifier receiver 232 is mounted on the non-display surface. An identifier transmitter 231, for example, an infrared signal transmitter is mounted on the surface opposite to the surface of each display sheet in the specific direction. For example, when the surface of the display sheet in the specific direction is top, the identifier transmitter 231 is mounted on the non-display surface. When the surface is back, the identifier transmitter 231 is mounted on the display surface.

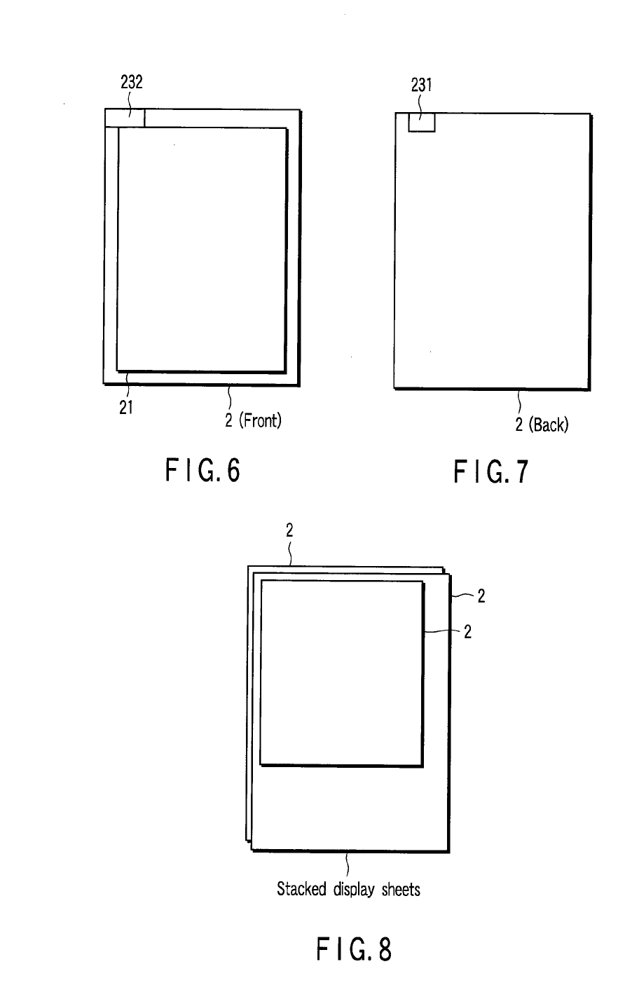

In FIG. 6, the infrared signal receiver as the identifier receiver 232 is mounted on the upper-left corner of the display surface of the display sheet 2 when the specific direction is forwarded. In FIG. 7, the infrared signal transmitter as the identifier transmitter 231 is mounted on the upper-left corner (when viewed from the top) of the non-display surface of the display sheet 2, that is, on the rear side of the infrared signal receiver, when the specific direction is forwarded.

In this case, when a plurality of display sheets 2 are stacked (bundled) as shown in FIG. 8, the infrared signal receiver and infrared signal transmitter of two adjacent display sheets 2 are faced with each other. Each display sheet 2 can detect the identifier of the following display sheet 2 before itself by receiving identifier information generated from the infrared signal transmitter of the following display sheet 2 with its infrared signal receiver even if the display sheets differ in size.

When each display sheet 2 notifies the video data transmitting apparatus 1 of the unit order information including the identifier of the display sheet 2 before and adjacent to itself and the itself identifier, the order relation information processor 14 of the video data transmitting apparatus 1 can specify at first the display sheet 2 notified the unit order information indicating absence of the adjacent display sheet 2 or that it is the top display sheet. Next, it can specify, as the second display sheet, the display sheet 2 notified the unit order information including the identifier of this specified display sheet as the identifier of the display sheet 2 before and adjacent to itself. Similarly, by tracing the unit order information, it is possible to specify the order relation among all display sheets 2.

The order relation information created in this way is stored in the order relation information memory 15.

The example using the infrared rays is described in the above embodiment. However, the identifier may be detected by attaching an identifier bar code to the non-display surface of each display sheet 2, mounting a bar code reader on the display surface of each display sheet 2 and reading the bar code. In addition, if identifier information displayed on the back or sent from the back can be detected on the front of each display sheet 2, any structure is available.

In the above description, the specific direction is assumed to be a forward direction, but it may be a backward direction.

In a configuration wherein the specific direction is assumed to be the forward direction, when the display sheet 2 can detect another display sheet in the forward direction of itself, it may be shifted to a power-saving mode such as decreasing of a brightness and so on. Then, the electric energy which the display sheets 2 aside from the top display sheet consume can be reduced. When the display sheet 2 is a portable device, the low power consumption is very effective.

In the case that the specific direction is taken to be the backward direction, the top display sheet 2 cannot detect to be top itself. In this case, the video data transmitting apparatus 1 may notify the display sheet 2 of migration from the location other than the top to the top, and migration from the top to the location other than the top. Alternatively, the video data transmitting apparatus 1 may instruct migration to a normal mode on the display sheet moved from the location other than the top to the top, and migration to a power-saving mode to the display sheet 2 moved from the top to the location other than the top.

In the present embodiment, before transmitting a display image to each display sheet 2 from the video data transmitting apparatus 1, the order relation information is created or updated, and each display image is transmitted to one of the display sheets based on this order relation information. Thereafter, if each display sheet 2 changes in order relation, it saves display contents. Accordingly, a user can treat each display device like a paper document. However, while a user browses a display image displayed on each display sheet 2, the display sheets 2 are replaced in order, and they are put on the desk so that the screens of plural display devices can be browsed at the same time. For this reason, a user may want to undo a plurality of display sheet 2 to a basic brochure state once again, build current order relation information into the video data transmitting apparatus 1 again, and transmit a display image again.

For such a case, there may be provided a reset indicator for indicating a reset to the video data transmitting apparatus 1 by a user. This reset indicator may be provided in the video data transmitting apparatus 1. It may be a device connectable to LAN for connecting between the wireless LAN access point 3 and the video data transmitting apparatus 1 or a device connected in wireless to the LAN access point 3. For example, when a user pushes a reset button (a real button or a GUI-shaped button), a reset instruction is given to the video data transmitting apparatus 1. The video data transmitting apparatus 1 which received the reset instruction updates the order relation information to current information, generates a display image having the same contents as the display image transmitted immediately before the reset instruction as needed and transmit the display image to the display sheet.

In the above embodiment, the reset indicator is provided. However, the following modification is available. For example, a specific identifier indicating a reset is defined as the identifier of the display sheet 2. An object to which the identifier transmitter 231 for transmitting identifier information indicating this specific identifier is attached is prepared for. For example, the specific direction is to be the forward direction. A user brings the identifier transmitter section 231 of the object close to the identifier receiver 232 of the top display sheet of a basic brochure state to make the identifier receiver 232 of the top display sheet receive identifier information indicating the specific identifier. The video data transmitting apparatus 1 can be configured to determine that a reset is designated when it receives a notice of the unit order information including this specific identifier.

The video data transmitting apparatus can be configured so that it determines that a reset is indicated when the unit order information is updated and the same basic brochure state continues not less than a given time after the video data transmitting apparatus 1 transmitted each display image to corresponding one of the display sheets 2. The display sheet 2 retains the same display image while repeating an operation that before the state that the forward rotation or backward rotation is performed continues not less than a constant time, the forward rotation or backward rotation is further performed, or while performing an operation of extracting some display sheets 2 from the basic brochure state and putting them on the desk. However, when the state that the forward rotation or backward rotation is done continues not less than a constant time, or the state that the extracted display sheets put on the desk are stacked to be undone to the basic brochure state continues not less than a constant time, the video data transmitting apparatus 1 determines that the reset is instructed.

In the present embodiment, the number m of display sheets 2 becoming the basic brochure state is not less than the number n of display images. This situation is preferable than the situation of m=n. However, if the user does not know n beforehand, or stacks the display sheets 2 without minding the number, it may occur that m largely exceeds n, or m is less than n.

If m is not less than n, the video data transmitting apparatus 1 may transmit all display images, and if m is less than n, it may transmit only the first to m-th display images. Alternatively, the following operation may be done. In other words, m and n are compared with each other at the time when the order relation information is created or updated before a display image is transmitted to each display sheet 2. If m is not less than n, the video data transmitting apparatus 1 transmits all display images. If m is less than n, because the display sheets 2 lack in number by r=n−m, a display image obtained by superimposing a message image such as “r display sheets lack” on the first display image may be transmitted to the top display sheet.

Further, n is compared with m. If m is not less than n, (r=m−n) display sheets 2 are unnecessary. In this case, an image obtained by superimposing a message image such as “r display sheets are superfluous” on the first display image may be transmitted to the top display sheet.

According to the present embodiment, the display images with order relation can be connected through a network, and displayed on the stacked display sheets with making the order of display images coincide with the order relation among the display sheets in a simple procedure. As a result, the stacked display sheets 2 can be used as a document made by stacking a plurality of papers usually used. This provides an effect of reducing an amount of document data to be printed to paper.

### Second Embodiment

There will be explained a video data communication system which deals with a case that the number of display images is larger than that of display sheets 2 in easy. In the present embodiment, the system is assumed to be fixed. In other words, the number of display sheets 2 is fixed but the order relation among the display sheets 2 is not fixed. Alternatively, the number of display sheets 2 or the order relation among the display sheets 2 is assumed to be fixed.

There is explained a point different from the first embodiment hereinafter.

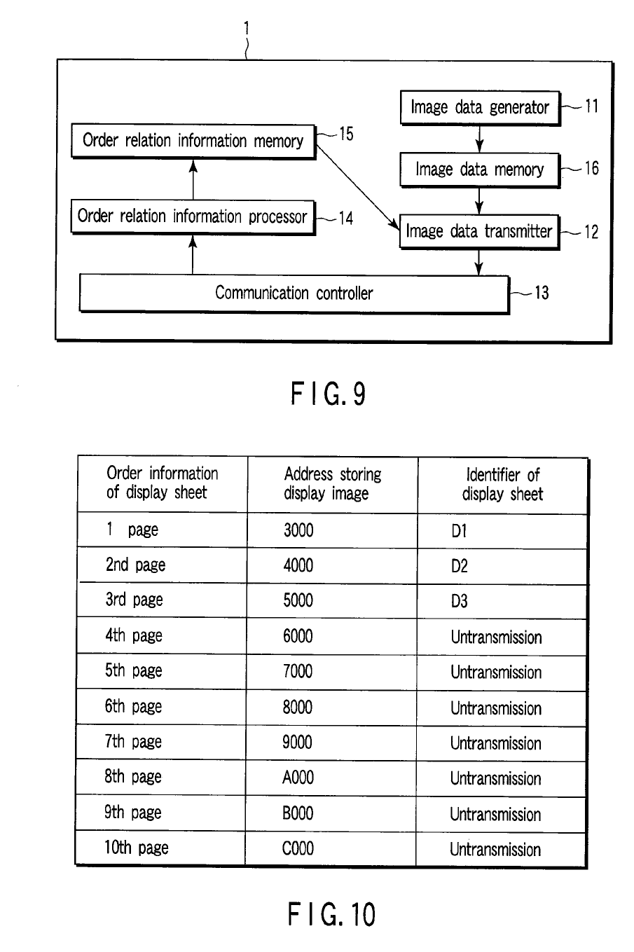

The video data transmitting apparatus 1 shown in FIG. 9 includes an image data memory 16 added to the video data transmitting apparatus 1 of FIG. 1. The image data memory 16 stores data of plural display images having a sequence which are generated by the image data generator 11 or input from an input device (not shown) (or information indicating a location at which data is stored), image order information indicating the order of each display image and information concerning a destination display sheet (e.g., identifier of the display sheet 2 corresponding to destination of the display image in the sent case and information indicating an unsent state in the unsent case.

The image data memory 16 may retain “information making it possible to generate a display image and order information” instead of “a display image and order information”. The “information making it possible to generate a display image and order information” is a drawing instruction that the image data generator 11 receives from the application making it possible to display document data, for example.

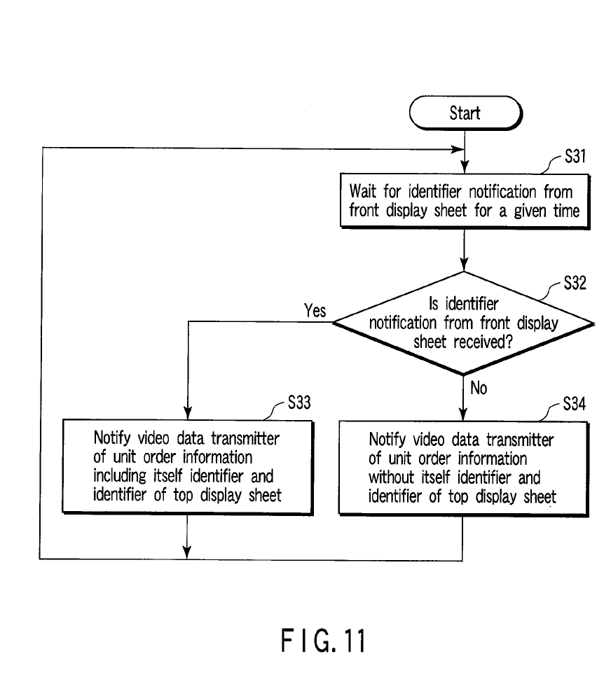

An example of information stored in the image data memory 16 is shown in FIG. 10. The configuration of the receiver 2 is basically similar to that of FIG. 5. In the present embodiment, when the order relation information changes, display images are transmitted to the display sheets 2 using the information of the image data memory 16 so as to match a new order relation.

In the present embodiment, when, for example, three display sheets 2 are requested to display document data of ten pages, the image data generator 11 generates the image of each page of the document data and stores the display image of each page in the image data memory 16. The display images of three pages of ten pages are transmitted to the display sheets 2 (identifiers are assumed to be D1, D2, D3 from the top sequentially). The information stored in the video data memory 16 in this state is shown in FIG. 10.

Subsequently, when a new display sheet 2 is added to the backmost display sheet, the video data transmitting apparatus 1 receives a notice from the new display sheet 2, for example, a notice indicating that the identifier thereof is assumed to be D4 and the identifier of the display sheet therebefore is assumed to be D3. The order relation information processor 14 updates order relation information. On the basis of this update result and information stored in the image data memory 16, the image data transmitter 12 transmits the image of the fourth page to the new display sheet 2. Subsequently, the information of the image data memory 16 is updated. In the example of FIG. 10, the item “Identifier of display sheet” of the display image of the fourth page is updated from “Unsent state” to “D4”.

Even when the top display sheet 2 (identifier=D1) is migrated to the backmost location, the video data transmitter receives, from the display sheet 2, a notify indicating that the identifier thereof is D1, and the identifier of the display sheet therebefore is D4 or a notify indicating that the identifier thereof is D2 and there is no display sheet therebefore, and updates the order relation information. On the basis of this update result and information stored in the image data memory 16, the image data transmitter 12 transmits the image of the fifth page to the display sheet 2 migrated to the backmost location. Subsequently, the information of the image data memory 16 is updated.

In the example of FIG. 10, the item “Identifier of display sheet” of the display image of the fifth page is updated from “Unsent state” to “D1”. In this case, the display image of the first page is updated to information aside from “D1”, for example, “display end” or “unsent state”.

Even when the number of display images is more than the number of display sheets 2, the image that could not be displayed at the time of display request can be displayed by adding the display sheet 2 or replacing the order of the display sheets 2.

By establishing organization rebuilding the order relation in this way, a display image may not be transmitted, when the display sheet 2 is not top, but may be transmitted when it is migrated to the top location. In this case, transmission of the display image to the display sheet 2 which is not top can be omitted, resulting in making it possible to reduce the traffic due to the video data transmitting apparatus 1. This can get rid of a wasteful receiving process of the display sheet 2 and reduce power consumption of the display sheet 2. When the display sheet 2 is portable, low-power consumption is very effective.

There will be explained a procedure of creation of order relation information. A procedure that the display sheet 2 notifies the video data transmitting apparatus 1 of unit order information is shown in FIG. 11.

The unit order information informer 24 of the display sheet 2 waits for, for a given length of time, a condition that the identifier receiver 232 of the adjacent display sheet detector 23 receives an identifier notification from the forward display sheet 2 (step S31). If, during the given length of time, the unit order information informer 24 receives an identifier notification from the forward display sheet 2 (step S32), the unit order information informer 24 notifies the video data transmitting apparatus 1 of unit order information including the identifier of the corresponding display sheet and the identifier received from the forward display sheet 2.

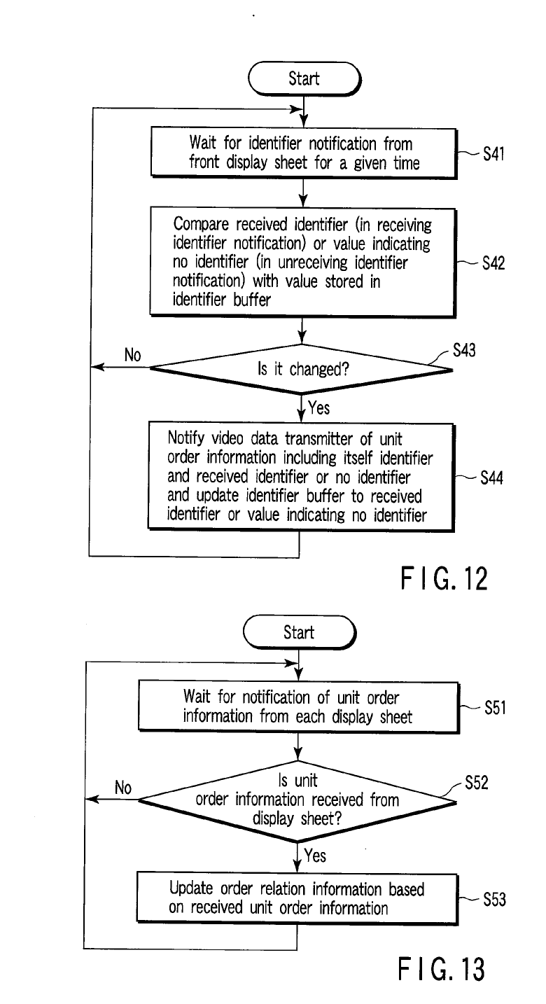

If the unit order information informer 24 receives no identifier notification from the forward display sheet 2 (step S32), it notifies the video data transmitting apparatus 1 of the unit order information including the identifier of the corresponding display sheet and information indicating that there is no forward display sheet 2 or the forward display sheet is not detected. The procedure according to which the display sheet 2 notifies the video data transmitting apparatus 1 of the unit order information is shown in FIG. 12.

The unit order information informer 24 of the display sheet 2 waits for, for a given length of time, a condition that the identifier receiver 232 of the adjacent display sheet detector 23 receives an identifier notification from the forward display sheet 2 (step S41). During the given length of time, when the unit order information informer 24 receives an identifier notification from the forward display sheet 2, it compares the received identifier with a value stored in the identifier buffer (not shown). When receiving no identifier notification, the unit order information informer 24 compares a value stored in the identifier buffer with a value indicating that there is no identifier (step S42).

If they do not coincide with each other, that is, a change is in the forward display sheet 2 (step S43), the display sheet notifies the video data transmitting apparatus 1 of the unit order information including the identifier thereof and the received identifier or information indicating there is no received identifier of the forward display sheet and updates the identifier buffer by the received identifier or a value indicating there is no received identifier (step S44).

FIG. 13 illustrates an example of a procedure according to which the video data transmitter 2 creates or updates the order relation information based on the unit order information received from the display sheet 2. The order relation information processor 14 of the video data transmitting apparatus 1 waits for a notice of unit order information from each display sheet 2 (step S51, S52). When receiving the unit order information from the display sheet 2 (step S52), the order relation information processor 14 updates the order relation information based on the received unit order information (step S53).

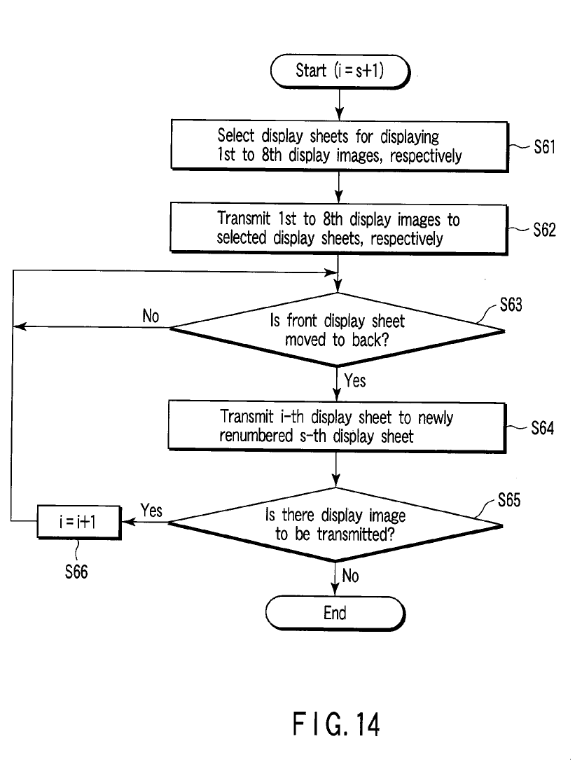

There will be explained an example of a processing procedure of the video data transmitting apparatus 1 referring to FIG. 14. This procedure corresponds to the forward rotation schematically.

The number s of display images transmitted at first is assumed to be a specific value satisfying≦s≦m, where the number of display devices is 2. For example, the value of s is determined beforehand. If s>m at the time of creation of the order relation information, the value of s may be modified by a method determined beforehand. For example, s=m, s=m/2 (in the case that m is the even number) or s=m/2-0.5 (in the case that m is the odd number) is preferable.

The following procedure is assumed to be used when s<n where n is the number of display images. In the case of s≧n, at first, all display images are transmitted, and the process is completed. All display images are assumed to be prepared in the image data memory 16 (by generation or input) before the start of the following procedure. Creation/update of the order relation information is assumed to be done before the following procedure.

At first, the process is started with i=s+1. The image data transmitter 12 selects the first to s-th display sheets 2 that are destinations of the first to s-th display images (step S61), and transmits the first to s-th display images to the selected display sheets 2 respectively (step S62).

The order relation information processor 14 monitors whether the display sheets change over from a current basic brochure state to a basic brochure state that the forward rotation is done or the current top display sheet 2 migrates to the backmost location. When it is detected that the current top display sheet 2 is migrated to the backmost location (step S63), the i-th display image is transmitted to the s-th display sheet which is renumbered in the new basic brochure state (step S64). If the display image to be transmitted remains (step S65), i is incremented one by one (step S66), and the process returns to step S63.

As described above, whenever the state that the forward rotation is done is detected, a process of transmitting the display images one by one to the new s-th display sheet is done repeatedly till the transmission of all display images completes.

The process does not advance to step S64 immediately when the migration of the current top display sheet 2 to the backmost location is detected in step S63, but it may advance to step 64 when what the state that the current top display sheet is migrated to the backmost location continues for a given length of time is detected.

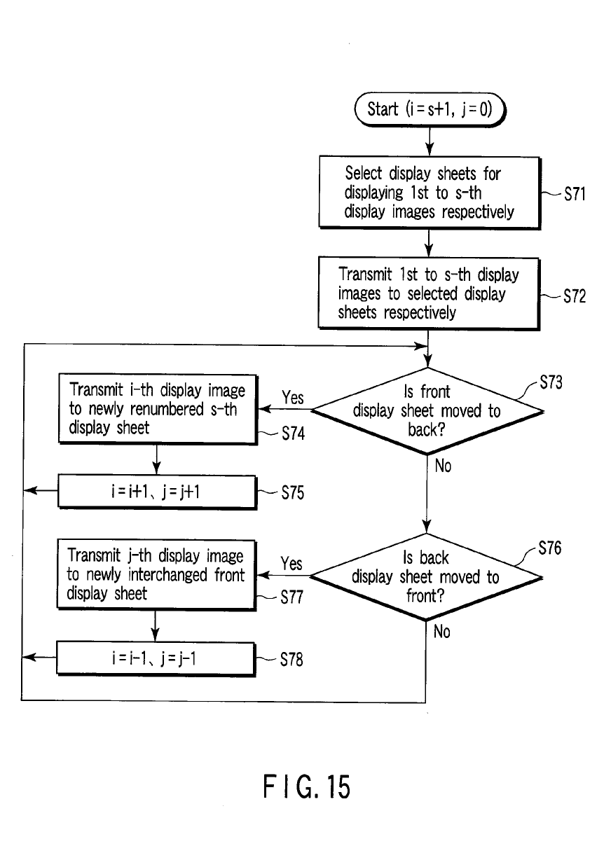

Another processing procedure of the video data transmitting apparatus 1 is shown in FIG. 15. This procedure corresponds to the forward rotation and backward rotation schematically. The number s of display images transmitted at first is assumed to be a specific value satisfying ≦s≦m, where the number of display devices is 2. For example, the value of s is determined beforehand. If s>m at the time of creation of the order relation information, the value of s may be modified by a method determined beforehand. For example, s=m, s=m/2 (in the case that m is the even number) or s=m/2-0.5 (in the case that m is the odd number) is preferable.

The following procedure is assumed to be used when s<n where n is the number of display images. In the case of s≧n, at first, all display images are transmitted, and the process is completed. All display images are assumed to be prepared in the image data memory 16 (by generation or input) before the start of the following procedure. Creation/update of the order relation information is assumed to be done before the following procedure.

At first, the process is started with i=s+1. The image data transmitter 12 selects the first to s-th display sheets 2 that are destinations of the first to s-th display images (step S61), and transmits the first to s-th display images to the selected display sheets 2 respectively (step S72).

The order relation information processor 14 monitors whether the display sheets change over from a current basic brochure state to a basic brochure state that the forward rotation is done or the current top display sheet 2 is migrated to the backmost location or whether they become the basic brochure state that the backward rotation is done or the current backmost display sheet 2 is migrated to the top. When it is detected that the current top display sheet 2 is migrated to the backmost location (step S73), the i-th display image is transmitted to the s-th display sheet which is renumbered in the new basic brochure state (step S74). i and j are incremented one by one (step S75), and the process returns to steps S73 and S76.

On the other hand, when it is detected that the current backmost display sheet 2 is migrated to the top (step S76), the j-th display image is transmitted to the new top display sheet 2 in the new basic brochure state (step S77). i and j are decremented one by one (step S78), and the process returns to steps S73 and S77.

As described above, when the state that the forward rotation or backward rotation is done is detected, a process of transmitting the corresponding display image to the new s-th or new top (first) display sheet 2 is done repeatedly according to the detection.

The process does not advance to steps S64/S77 immediately when the migration of the current top/backmost display sheets 2 to the top/backmost locations is detected in step S73/S76, but the process may advance to steps S74/S77 when what the state that the current top/backmost display sheets are migrated to the backmost/top locations continues for a given length of time is detected.

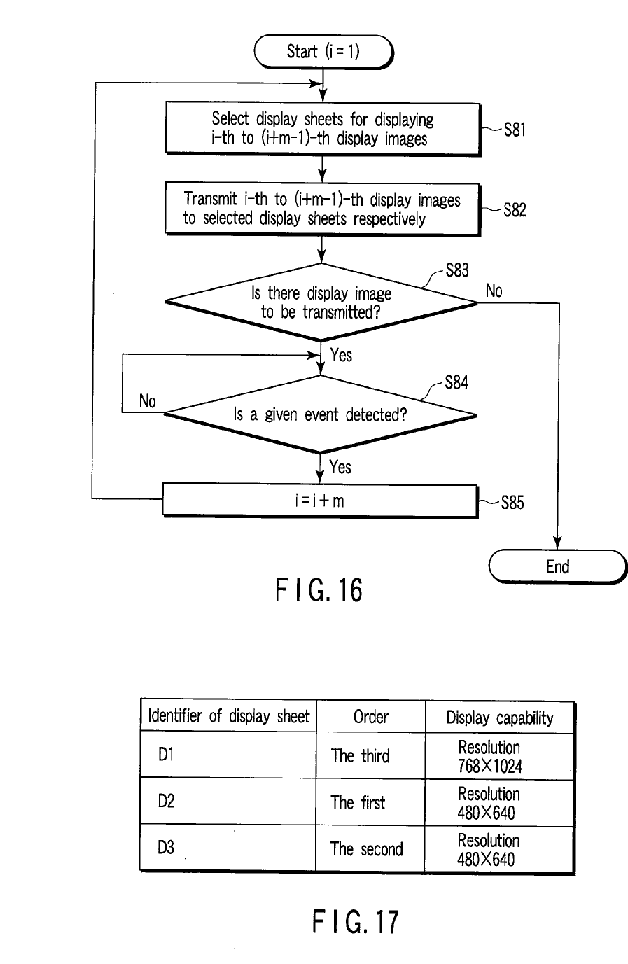

FIG. 16 illustrates an example of another processing procedure of the video data transmitting apparatus 1. This procedure transmits a number of display images corresponding to the number of display sheets 2 repeatedly. The number m of display sheets 2 is assumed to be less than the number n of display images. In the case of s≧n, at first, all display images are transmitted, and the process is completed.

All display images are assumed to be prepared in the image data memory 16 (by generation or input) before the start of the following procedure. Creation/update of the order relation information is assumed to be done before the following procedure.

At first, the process is started with i=1. The image data transmitter 12 selects the first to m-th display sheets 2 that are destinations of the i-th to (i+m−1)-th display images (i.e., m display images of unsent display images that precede in order) (step S81), and transmits the i-th to (i+m−1)-th display images to the selected first to m-th display sheets 2 respectively (step S82).

It is monitored whether a given event is detected. For example, the order relation information processor 14 monitors whether the basic brochure state is returned to the current basic brochure state by doing the forward rotation m times or whether the instruction for instructing to transmit next m display images is given from a user by a method similar to, for example, the reset instruction described previously. When a given event is detected (step S84), i is incremented one by one (step S85), and the process returns to step S81. The image data transmitter 12 selects the first to m-th display sheets 2 that are destinations of the next m display images, i.e., the i-th to (i+m−1)-th display images (step S81), and transmits the i-th to (i+m−1)-th display images to the selected first to m-th display sheets 2 respectively (step S82).

As described above, the process for transmitting unsent display images in units of m display images is repeated till transmission of all display images completes (step S83). When only t (<m) display images remain at the time of transmission of the last display image, m=t is set and the steps S81 and S82 are carried out.

The display sheet 2 aside from the top may be shifted to a power-saving mode as explained in the first embodiment. The present video image transmitting apparatus may be configured so that a user can indicate a reset as explained in the first embodiment. The top display sheet 2 may display various kinds of messages as explained in the first embodiment.

### Third Embodiment

In the present embodiment, there is explained a point different from the first embodiment and the second embodiment.

As illustrated in FIG. 17, the order relation information stored in the order relation information memory 15 of the video data transmitting apparatus 1 in the first and second embodiments may be stored in the memory in association with information concerning the display capability of each display sheet 2. The display capability indicates, for example, a resolution, a color number, a display speed, an image format which can be displayed.

The information concerning the display capability has only to be set at the time of system setup when the system is fixed. In the case that the system is not fixed, when the IP address of the connectable display sheet 2 is acquired using UPnP, it may be acquired from each display device. This method makes it possible to generate an image appropriate for the display capability of each display sheet 2 and transmit it.

In the first and second embodiments, when transmitting a display image to each display sheet 2, the video data transmitting apparatus 1 can derive the display capability of the destination display sheet 2 from the order relation information memory 15, and generate and transmit a display image appropriate for the display capability. In, for example, the second embodiment, when transmitting the display image stored in the image data memory 16 to a display sheet 2 added newly, the video data transmitting apparatus 1 can derive the display capability of the destination display sheet 2 from the order relation information memory 15, and generate and transmit the display image appropriate for the display capability.

For example, when the resolution of the display sheet 2 added newly is VGA (640*480 pixels), the display image can be transmitted by being reduced to a VGA size. Otherwise, when the display sheet 2 added newly does not have resolution sufficient to displaying the display image, the video data transmitting apparatus 1 does not transmit the display image and notifies a user of insufficiency of resolution to promote addition of another display sheet having other resolution.

### Fourth Embodiment

In the present embodiment, there is explained a point different from the above embodiments.

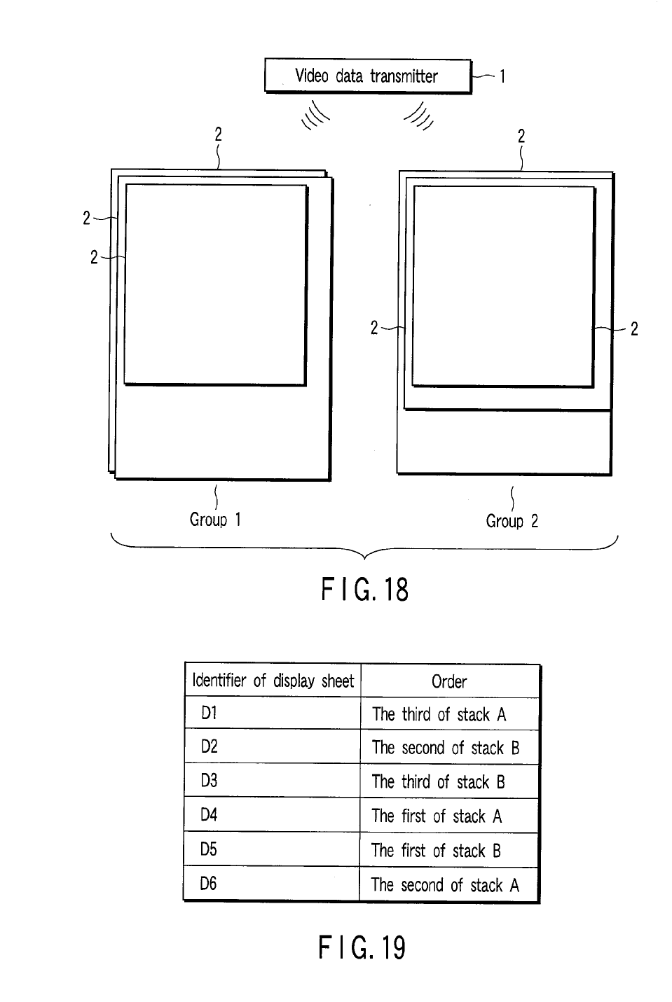

In the first to third embodiments, when a group of a plurality of stacked display sheets 2 are divided into a plurality of groups as shown in FIG. 18, that is, there are a plurality of groups of basis brochure states, the order relation information memory 15 may store information indicating that each display sheet 2 belongs to what group as well as information indicating the order of each display sheet 2 as illustrated in FIG. 19.

When the display sheet 2 displays new document data under such conditions, the video data transmitting apparatus 1 selects the group of display sheets which do not display the display images based on the information stored in the order relation information memory 15 and the image data memory 16, and transmits the display image so that the order of document data coincides with the order of the display sheets 2. When there is no group of display sheets that display the display image, the video data transmitting apparatus 1 inquires a user whether the display content of the display sheet 2 of which group are changed. The video data transmitting apparatus 1 transmits the display image to the display sheets of the group selected by the user so that the order of display sheets 2 coincides with the order of document data.

According to such a control, it becomes possible by intuitive operation of the user which divides stacked display sheets 2 into a plurality of groups to display a plurality of document data streams on a plurality of display sheets 2 individually in a simple procedure.

### Fifth Embodiment

In the above embodiments, the display sheet is assumed to be a single-side display type display sheet wherein a display unit is provided only on one side. In the present embodiment, there is explained a video data transmitting apparatus using a double-side display type display sheet wherein display units are provided on both surfaces thereof respectively.

There is explained a point different from the above embodiments. The double-side display type display sheet 2 can identify the first surface and the second surface in a system. For example, different identifiers may be allocated to the first surface and second surface of the display sheet 2. In this case, the display sheet 2 results in having two identifiers.

Further, for example, only one identifier is allocated to the display sheet 2, and other information elements, for example, port numbers may be allocated to the first surface and the second surface. Further, for example, only one identifier is allocated to the display sheet 2, and a display image for the first surface and a display image for the second surface may be transmitted to the display sheet as a set collectively. There is a method of transmitting only a display image for one surface and making a display image for the other surface null.

When the system is fixed, the first surface and second surface of the display sheet 2 may be treated as adjacent independent display sheets of the previous embodiment. For example, in the case of the single-side display type, when the display sheets D2, D3 and D1 are stacked in this order, the display sheet D2 is the first, the display sheet D3 is the second, and the display sheet D1 is the third. However, in the case of the double-side display type, the first surface of the display sheet D2 is the first, the second surface of the display sheet D2 is the second, the first surface of the display sheet D3 is the third, the second surface of the display sheet D3 is the fourth, the first surface of the display sheet D1 is the fifth, and the second surface of the display sheet D1 is the sixth.

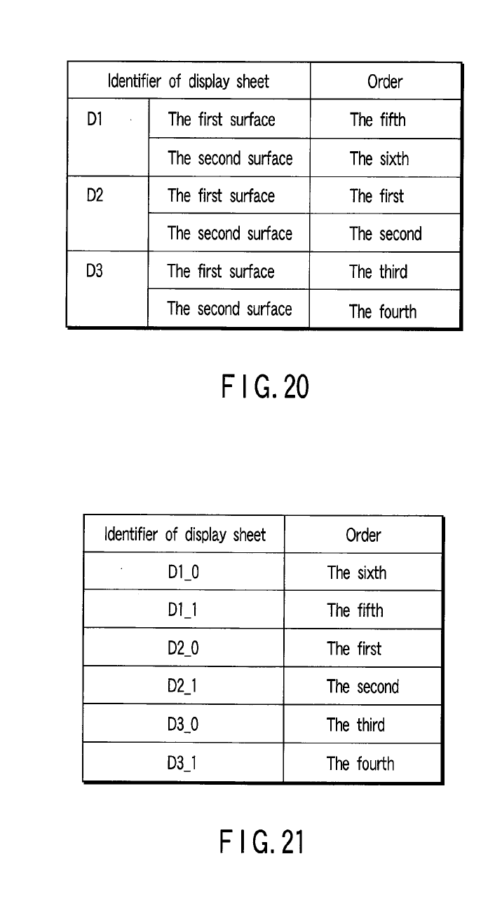

An example of order relation information of this case is shown in FIG. 20. In this case, the single-side display type display sheets 2 and double-side display type display sheets 2 can be mixed. When the system is not fixed, in other words, when the number of double-side display type display sheets and the number of single-side display type display sheets are fixed, but the order relation of the display sheets 2 is not fixed, when the total number of display surfaces of display sheets 2 is fixed, but the number of double-side display type display sheets and the number of single-side display type display sheets are not fixed and the order relation of display sheets 2 is not fixed, or when the number of display sheets or the total number of display surfaces is not fixed and the order relation of display sheets is not fixed, there are two following methods.

The first surface (front) and second surface (back) of each display sheet 2 are distinguishable on the face thereof, and the display sheets can be stacked in order of “front and back” with the first surfaces of all display sheet 2 being directed toward the same direction without a user making a mistake. For example, marks are attached to the front and back of each display sheet with different designs at the front and back for distinguishing between the upper and lower portions and between the front and back surfaces like a telephone card. In this case, like the previous embodiment, only one set of an identifier receiver 232 and an identifier transmitter 231 may be provided for each display sheet 2 as shown in FIGS. 6 and 7, for example, and the order relation information is created based on the unit order information from each display sheet 2. In this time, the order relation information has only to be created in consideration of the second surface.

In other words, if the order relation information is created as shown in FIG. 2 in the previous embodiment, the order relation information shown in FIG. 20 has only to be created by adding the order related to the second surface to the order related to the first surface of the display sheet 2.

When the double-side display type display sheets and single-side display type display sheets are mixed, the identifier of each display sheet and information indicating whether the display sheet is either the double-side display type or the single-side display type are retained. When the order relation information is created, only the display sheet falling under the double-side display type has only to add the order of the second surface of the display sheet to the order of the first surface thereof.

There will be explained an example wherein the first surface (front) and second surface (back) of each display sheet 2 are not fixed.

In the above example, only one set of an identifier receiver 232 and an identifier transmitter 231 may be provided for each display sheet 2 as shown in FIGS. 6 and 7. In this example, two sets, each including an identifier receiver 232 and an identifier transmitter 231, are assumed to be provided. For example, an infrared signal photo-receiver as the identifier receiver 232 is provided on the upper left portion of the first surface as shown in FIG. 6. An infrared signal transmitter as the identifier transmitter 231 may be provided on the upper right portion of the first surface and an infrared signal transmitter as the identifier transmitter section 231 may be provided on the upper left portion of the second surface (when viewed from the first surface) as shown in FIG. 7. An infrared signal receiver as the identifier receiver 232 may be provided on the upper right portion of the second surface.

According to the above configuration, if the basis brochure state is formed with the first surface and second surface of each display sheet being directed toward any direction, the same state can be obtained. In this case, each display sheet 2 has only to notify the video data transmitting apparatus 1 of both of the unit order information concerning the first surface of itself and the unit order information concerning the second surface of itself or one of them. When each display sheet 2 notifies of both of the unit order information concerning the first surface and the unit order information concerning the second surface, they may be notified of separately, and by being collected to unit order information.

The video data transmitting apparatus 1 can obtain adjacency relation between the first surface and second surface of each of all display sheets (in side-by-side order) based on the notice from each display sheet 2. However, in this case, because there are two display sheets 2 whose display surfaces can be browsed, it cannot be specified whether which display sheet is the top. In the present embodiment, the video data transmitting apparatus 1 determines as the top either one of the display surfaces of two display sheets. The selection of display surfaces may use any method. They may be selected in random. If the identifiers are indicated by numbers, the display sheet having a smaller number may be selected.

An example of order relation information of this case is shown in FIG. 21. In this example, D1_0 indicates the first surface of the display sheet of the identifier D1, and D1_1 indicates the second surface of the display sheet of the identifier D1. The first surface of the display sheet of the identifier D2 and the first surface of the display sheet of the identifier D1 can become the top surface. However, the first surface of the display sheet of the identifier D2 is shown as the top in the example of FIG. 21.

In the case that the video data transmitting apparatus 1 transmits the display images two by two to each display sheet 2 based on the order relation information, a case that a user directs the top display sheet toward itself and a case that the user directs the backmost display sheet toward itself are conceivable. The user determines whether the top display sheet is directed toward itself or the backmost display sheet is directed toward itself. When the backmost display sheet is directed toward the user, a plurality of display sheets 2 arranged in the shape of brochure may be reversed so that the top display sheet is directed toward the user. However, the system may provide a guide for the user to recognize the direction.

For example, when the user bundled up a plurality of display sheets 2, before displaying a display image, a message of “Please direct this surface toward the top” and “Please direct this surface toward the down” or an image recognizable as the front intuitively and an image recognizable as the back intuitively may be displayed for a moment.

When the user bundled up a plurality of display sheets 2, before a display image is displayed or after the video data transmitting apparatus 1 transmits the display images two by two to each display sheet 2, information capable of distinguishing the front or the back may be displayed out of the display screen of the display sheet 2.

Each function described above are implemented by being written as software and processed by the computer having a suitable mechanism. Also, the embodiments can be implemented as programs for making a computer execute a predetermined procedure, for making a computer function as a given measure, or for making a computer realize a given function. In addition, the embodiments can be carried out as a computer readable recording medium recorded the program.

According to the present invention, when a plurality of image data having order relation is transmitted from a video data transmitter to a display sheet having order relation, and displayed thereon, even if order relation among a plurality of display sheets bundled up in a shape of brochure, the number of image data, the number of display sheets or the total number of display surfaces changes, the system can deal with the change flexibility.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video data transmitting apparatus to transmit video data to a plurality of stackable display devices individually, the apparatus comprising:
a memory to store management information indicating corresponding relation between identification information elements for identifying a plurality of stackable display devices and orders of the display devices;
an image data generator to generate a plurality of image data streams having a sequence according to the sequence; and
an image data transmitter to transmit the image data streams to the display devices with order relation among the image data streams matching with order relation among the display devices based on the management information.

2. A video data transmitting apparatus to transmit video data to a plurality of stackable display devices individually, the apparatus comprising:
a management information memory to store management information indicating corresponding relation between identification information elements for identifying a plurality of stackable display devices and orders of the display devices;
an image data memory to store a plurality of image data streams having a sequence according to the sequence; and
an image data transmitter to transmit the image data streams to the display devices with order relation among the image data streams matching with order relation among the display devices based on the management information.

3. The video data transmitting apparatus according to claim 2, wherein the image data memory stores information indicating the image data streams, original information thereof or a storing location at which each image data stream is stored, orders of the image data streams, and identification information of the display devices transmitted the image data streams, with corresponding relation among them.

4. The video data transmitting apparatus according to claim 2, further comprising an image data generator to generate the image data streams, and the image data memory stores the image data streams generated by the image data generator.

5. The video data transmitting apparatus according to claim 2, further comprising an image data input unit configured to input the image data streams, and the image data memory stores the image data input by the image data input unit.

6. The video data transmitting apparatus according to claim 2, wherein when the management information changes, the image data transmitter transmits the image data streams to the display devices with a state that new order relation among the display devices is matched with the order relation among the image data streams, based on the changed management information.

7. The video data transmitting apparatus according to claim 2, wherein the image data transmitter transmits the image data streams to only the display device defined as the top by the management information, or only the display device between the display device defined as the top by the management information and the display device defined as the order after a predetermined sequence from the display device defined as the top,

8. The video data transmitting apparatus according to claim 2, wherein the management information memory stores information indicating capability of each display device with the corresponding relation between the identification information elements and the orders of the display devices.

9. The video data transmitting apparatus according to claim 2, wherein the display devices are divided into a plurality of display groups, and the management information includes corresponding relation between the identifier information and the display groups, and the image data transmitter selects one group from the display groups referring to the management information at the time when a plurality of new image data streams are transmitted to the display devices, and transmits the new image data streams to only the display devices belonging to the selected display group with a state that the order relation among the image data streams matches with the order relation among the display devices.

10. The video data transmitting apparatus according to claim 2, further comprising a notice information receiver to receive notice information including identification information of each display device and identification information of another display device stacked on each display device in a specific direction with respect thereto or information indicating no another display device adjacent to each display device in the specific direction, and
a management information processor to create or update the management information based on the notice information received from each display device.

11. The video data transmitting apparatus according to claim 10 wherein the display device comprises an identification information notice transmitter to transmit a notice of identification information of itself in a direction opposite to the specific direction, and an identification information notice receiver to receive the notice of identification information of the another display device which is sent from the identification information notice transmitter of the another display device in the specific direction.

12. The video data transmitting apparatus according to claim 10 wherein the specific direction is a forward direction when viewed from each display device in a state that a plurality of display devices are stacked, and the management information processor creates or update the management information by taking the display device transmitted the notice including information indicating no another display device adjacent to the display device in the specific direction as the top display device in a state wherein the display devices are stacked.

13. The video data transmitting apparatus according to claim 10 wherein the specific direction is a backward direction when viewed from each display device in a state that the display devices are stacked, and the management information processor creates or update the management information by taking the display device transmitted the notice including information indicating no another display device adjacent to the display device in the specific direction as the backmost display device in a state wherein the display devices are stacked.

14. The video data transmitting apparatus according to claim 2, wherein the display device is a sheet-shaped display device.

15. A video data communication system comprising:
a plurality of stackable display devices; and an image data transmitter to transmit image data streams to the display devices individually, the image data transmitter including:
a management information memory to store management information indicating corresponding relation between identification information elements for identifying the display devices and display orders of the display devices;
an image data generator to generate a plurality of image data streams having a sequence according to the sequence; and
an image data transmitter to transmit the image data streams to the display devices with a state that order relation among the image data streams matches with order relation among display devices, based on the management information; and
the display device includes:
an image data receiver to receive the image data streams from the image data transmitter;
an image data display unit configured to display received image data streams;
a detector to detect identification information of another display device stacked on each display device in the specific direction; and
a transmitter to transmit the identification information of itself and notice information including the identification information of the another display device or information indicating no another display device to be detected; and
the image data transmitter includes a notice information receiver to receive notice information including identification information of each display device, identification information of another display device stacked on each display device in the specific direction or information indicating no another display device adjacent to each display device in the specific direction; and
a management information processor to create or update the management information based on the notice information received from each display device.

16. A video data communication system comprising:
a plurality of stackable display devices; and
an image data transmitter to transmit image data streams to the display devices individually,
the image data transmitter including:
a management information memory to store management information indicating corresponding relation between identification information elements for identifying the display devices and display orders of the display devices;
an image data memory to store a plurality of image data streams having a sequence according to the sequence; and
an image data transmitter to transmit the image data streams to the display devices with a state that order relation among the image data streams matches with order relation among display devices, based on the management information; and
the display device includes:
an image data receiver to receive the image data streams from the image data transmitter;
an image data display unit configured to display received image data streams;
a detector to detect identification information of another display device stacked on each display device in the specific direction; and
a transmitter to transmit the identification information of itself and notice information including the identification information of the another display device or information indicating no another display device to be detected; and
the image data transmitter includes a notice information receiver to receive notice information including identification information of each display device, identification information of another display device stacked on each display device in the specific direction or information indicating no another display device adjacent to each display device in the specific direction; and
a management information processor to create or update the management information based on the notice information received from each display device.

17. A display device stackable on another display device comprises:
an image data receiver to receive image data from a image data transmitter;
an image data display unit configured to display received image data;
a detector to detect identification information of another display device stacked on the display device in a specific direction; and
a transmitter to transmit notice information including identification information of itself and identification information of the another display device or information indicating no another display device to the image data transmitter.

18. The display device according to claim 17, further including a detector to detect a state that another display device is stacked on the display device, and operating in a power-saving mode in response to detection of the state.

19. A video data transmission method for transmitting video data to a plurality of stackable display devices individually,
storing, in a memory, management information indicating corresponding relation between identification information elements for identifying a plurality of stackable display devices and orders of the display devices;
generating a plurality of image data streams having a sequence according to the sequence; and
transmitting the image data streams to the display devices with order relation among the image data streams matching with order relation among the display devices based on the management information.

20. A video data transmission method for transmitting video data to a plurality of stackable display devices individually,
storing, in a memory, management information indicating corresponding relation between identification information elements for identifying a plurality of stackable display devices and orders of the display devices;
storing, in a memory, a plurality of image data streams having a sequence according to the sequence; and
transmitting the image data streams to the display devices with a state that order relation among the image data streams matches with order relation among the display devices based on the management information.

21. A computer readable storage medium storing instructions of a computer program which when executed by a computer results in performance of steps comprising:
storing, in a memory, management information indicating corresponding relation between identification information elements for identifying a plurality of stackable display devices and orders of plural display devices;
generating a plurality of image data streams having a sequence according to the sequence; and
transmitting the image data streams to the display devices with order relation among the image data streams matching with order relation among the display devices based on the management information.

22. A computer readable storage medium storing instructions of a computer program which when executed by a computer results in performance of steps comprising:
storing, in a memory, management information indicating corresponding relation between identification information elements for identifying a plurality of stackable display devices and orders of plural display devices;
storing, in a memory, a plurality of image data streams having a sequence according to the sequence; and
transmitting the image data streams to the display devices with a state that order relation among the image data streams matches with order relation among the display devices based on the management information.
